(19) United States
(12) Patent Application Publication
(10) Pub. No.: US 2011/0077788 A1
(43) Pub. Date: Mar. 31, 2011

(54) Wireless Power Distribution System and Device

(76) Inventors: Herman Chan, Somerset, NJ (US); Swen Anderson, Saxony (DE); Huimin Cao, Belle Mead, NJ (US)

(21) Appl. No.: 12/796,460

(22) Filed: Jun. 8, 2010

Related U.S. Application Data
(60) Provisional application No. 61/185,094, filed on Jun. 8, 2009.

(51) Int. Cl. G06F 1/26

(52) U.S. Cl. 700/291; 700/286

(57) ABSTRACT

The invention pertains to a system for monitoring and controlling power distribution including a power distribution device which has a module, a input line, and an output line. The input and output lines carry electrical power into an out of the module. The module has a switch in open or close position and a device wireless unit and a sensor. The sensor sends information regarding the electrical characteristics of the electric power being carried to the device microcontroller which causes a data to be sent wirelessly to the base unit. The base unit maintains a wireless connection for transmitting and receiving RF signals. The base unit receives the information regarding the electrical characteristics and sends it to a computer over a network.

### CROSS REFERENCE TO RELATED CASE

This application claims priority from U.S. Provisional Patent Application No. 61/185,094 filed Jun. 6, 2009, entitled “Wireless Power Distribution System and Device” which is incorporated herein by reference.

### BACKGROUND

The monitoring and control of power delivered to electricity consuming apparatuses presents problems for both industrial and residential use. This problem is of increasing importance due to environmental and economic concerns. To address these problems, devices which deliver power to such apparatuses have been provided with the ability to monitor the voltage, current, and power which have been delivered to one or more electric devices. Examples of such power delivery devices include power strips, power distribution unit, power cables, and any other device for delivering electricity from a source to an electric apparatus. Typically, this data has been displayed on a local display on the power delivery device such as, an LED, LCD or other display. Some power delivery devices allow this monitoring data to be transmitted by a wired data connection from the device using such protocols such as Ethernet, SNMP, or other wired protocols. Such devices may also have a switch under the control of the wired data connection. This relay (defined as a switch under the control of another electronic circuit). This allows for a limited control of power (on/off).

Such power monitoring is more useful if the data collection and control of many appliances are centralized. For example, in a household, the collection of power data from many appliances would allow determination of what the most profligate energy user is. In an industrial setting the opportunities for the collection of power data are extraordinarily numerous. For one example, a data center, the collection of the energy usage of many different electronic devices, including servers, is very useful in determining which servers are being utilized in an energy inefficient manner. Such information is useful in saving power and as such energy in a data center. However, in these and other such applications, where the collection of monitoring of power data into a central source is required, there exists a well-known cabling problem. Each and every power delivery device capable of power monitoring must be wired by cable to send the data back to the central data collection source. Such cabling represents a significant problem and expense. First, the installation of such cabling is a significant expense in the startup of any data center. Further, the installation of any server in a data center includes the additional expense of cabling, which is a significant fraction of the installation cost. Therefore, there remains in the field a need for a system and method of collecting data from numerous power delivery devices and for controlling numerous power delivery devices without the necessity of extensive cabling.

### SUMMARY

The invention pertains to a system for monitoring and controlling power distribution. It includes a power distribution device which has a module, a input line, and a output line. The input and output lines carry electrical power into an out of the module. The module has a switch in an open or closed position and a relay that controls the switch, a sensor that senses certain electrical characteristics of the input or output electric power, and a device wireless unit for obtaining a wireless connection that includes a device intended for transmitting and receiving signals and a device microcontroller that controls the relay, the sensor and the device wireless unit. The sensor sends information regarding the electrical characteristics of the electric power being carried to the device microcontroller which causes data to be sent wirelessly to the base unit. The base unit or base station has a base microcontroller for controlling its functions, a base wireless unit for maintaining a wireless connection, a network port, an interface to a computer, and an antenna for transmitting and receiving RF signals. The base unit receives the information regarding the electrical characteristics and sends it to a computer over a network. The base microcontroller may issue instructions to the device microcontroller over the wireless connection to have the relay service with an open or closed position.

The invention further pertains to methods of power monitoring and control, which include the sensing of electrical characteristics, sending said electrical characteristics through a device microcontroller to a device wireless unit, transmitting said electrical characteristics over a wireless connection to said device wireless unit, receiving the electrical characteristics over the wireless connection. The electrical characteristics are received by a base station which then processes the electrical characteristics and as appropriate sends the electric characteristics to a network port or a direct interface to computer. Alternatively, the base station may receive and send to the power distribution device switch commands that causes the relay to open or close a switch power distribution device.

The invention further pertains to the formation of a mesh network of power distribution devices and a base station, such that interference between a power distribution device and the base station is routed around by sending the information to other power distribution devices that do not have such interference.

### BRIEF DESCRIPTION OF THE DRAWINGS

FIG. 1 shows a diagrammatic top view of a power distribution system using a mesh network in accordance with one embodiment of the invention.

FIG. 2 shows a diagrammatic top view of a power distribution system using a star network in accordance with another embodiment of the present invention.

FIGS. 3 through 6 shows various embodiments of a power distribution devices.

### DETAILED DESCRIPTION

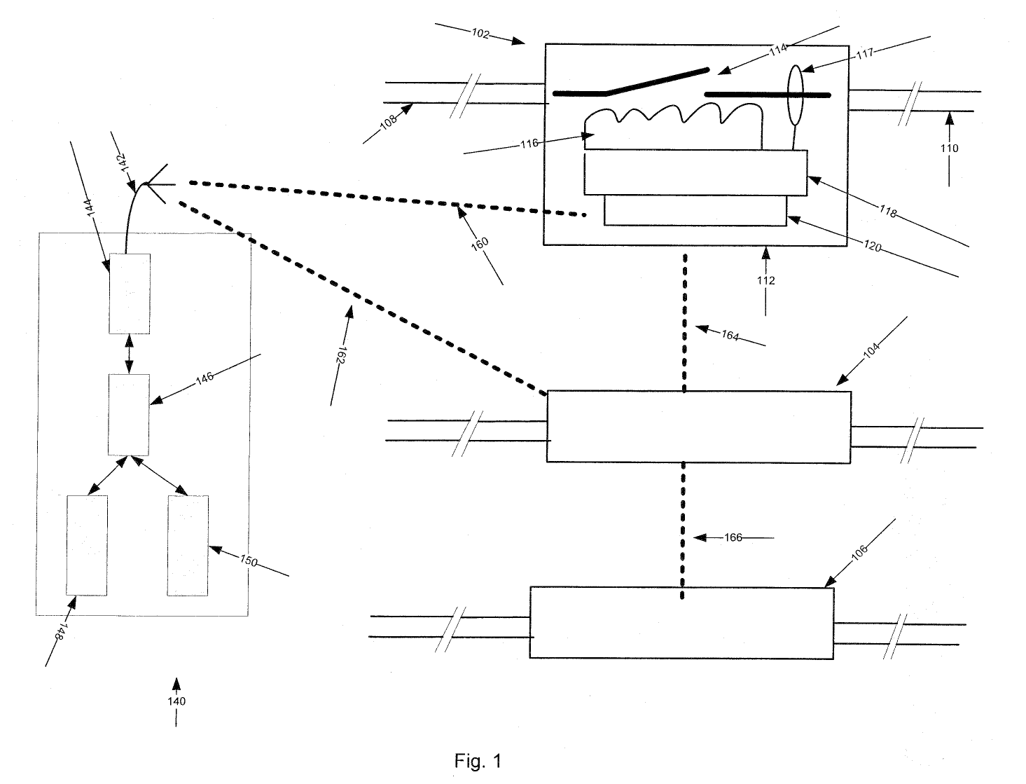

FIG. 1 shows one embodiment of the present invention. Power distribution system 100 includes power transmission devices 102, 104, and 106 and base station 140. Power transmission device 102 includes AC power input line 108 and AC power output line 110. Electrically connected in between lines 108 and 110 is power monitoring and control module 112. Module 112 includes switch 114, relay 116 sensor 117, microcontroller 118 and wireless unit 120. The switch 114 is any switch capable of either allowing or blocking the flow of current. Many different switches are usable in this particular embodiment as will be understood by those skilled in the art. Further, the relay 116 which controls switch 114 also has many potential implementations which are well known to those skilled in the art. Further, sensor 117 has many potential implementations which are well known to those skilled in the art for detecting voltage or current at various levels of accuracy. Microcontroller 118 may, in various implementations, include both hardware, software, or firmware, the particular implementation of both hardware, software, and firmware in a microcontroller 118 is well known to those skilled in the art. Wireless unit 120 will be further discussed below. Power distribution devices 104 and 106 have similar interior structure. Base station 140 includes antenna 142, wireless unit 144, and base microcontroller 146. An interface unit 148 is electrically connected to the controller 146. A network port 150 is electrically connected to microcontroller 146. The microcontroller is electrically connected to wireless unit 144, which electrically connected to antenna 142.

In operation, AC current travels through AC power input line 104 and into module 112. If switch 114 is closed, AC flows through module 112 and out AC power output line 110. When the switch is open the circuit is cut and there no flow of electrical current and, as such power. Sensor 117 detects either or both of the current and the voltage passing through the closed switch 114. Sensor 117 communicates this data to the microcontroller 146. Microcontroller 146 has a limited buffer memory in which to store said data. The relay 116 is controlled by microcontroller 118, and in turn controls the switch 118.

A wireless connection 160 exists between base station 140 and power distribution device 102. This wireless connection is maintained by base wireless unit 144 through antennae 142 and device wireless unit 120. The power data from sensor 117 can be wirelessly communicated to base station 140. From there, it may be transferred to either a network via network port 150, or directly to a computer or specialized terminal or other piece of equipment via interface 148. The network port 150 or interface 148 could utilize a number of protocols for communication, including either individually or in combination, Ethernet, TCP/IP, SNMP. MODBUS, IPMI, or other well-known protocols. Instructions for the device microcontroller 114 to cause the relay 116 to open or close the switch 112 from a user passes through either the network port 150 or the interface 148 through the base station 140 and over the wireless connection.

This wireless connection can be implemented in a number of different radio frequencies and communication protocols. In one embodiment the wireless connection 160 is a WLAN (Wi-Fi) connection. In another embodiment of the present invention the wireless connection 160 is implemented using a Bluetooth standard. In another embodiment of the present invention the wireless connection 160 is implemented using Wireless USB standard. In another embodiment of the present invention the wireless connection 160 is implemented using the Zigbee standard. In yet another embodiment of the present invention the wireless connection is implemented using a Z-Wave protocol.

Z-Wave is a low-power wireless technology designed specifically for remote control applications. Unlike Wi-Fi and other IEEE 802.11-based wireless LAN systems that are designed primarily for high-bandwidth data flow, the Z-Wave RF system operates in the sub Gigahertz frequency range and is optimized for low-overhead commands such as on-off (as in a light switch or an appliance) and raise-lower (as in a thermostat or volume control), with the ability to include device metadata in the communications. Because Z-Wave operates apart from the 2.4 GHz frequency of 802.11 based wireless systems, it is largely impervious to interference from common household wireless electronics, such as Wi-Fi routers, cordless telephones and Bluetooth devices that work in the same frequency range.

Z-wave uses an intelligent mesh network topology and has no master node. Devices can communicate to another around obstacles or radio dead spots that might occur. A message from node A to node C can be successfully delivered even if the two nodes are not within range, providing that a third node B can communicate with nodes A and C. If the preferred route is unavailable, the message originator will attempt other routes until a path is found to the “C” node. Therefore a Z-Wave network can span much further than the radio range of a single unit, however with several of these hops a delay may be introduced between the control command and the desired result. In order for Z-Wave units to be able to route unsolicited messages, they cannot be in sleep mode. Therefore, most battery-operated devices are not designed as repeater units. A Z-wave network can consist of up to 232 devices with the option of bridging networks if more devices are required. Z-Wave protocol uses the 900 MHz ISM band with an effective one hop range of 100 feet in open air.

FIG. 1 illustrates this mesh network. Power distribution device 104 is shown with two alternate wireless connections 162 and 164. Data and instructions going to and from power distribution device 104 may go through either connection 162 or connections 164 and 160. Power distribution unit 106 is shown with communication connection 166 to power distribution device 104, which may then connection to the base station via connection 162 or through the power distribution device 102 via connections 164 and 160.

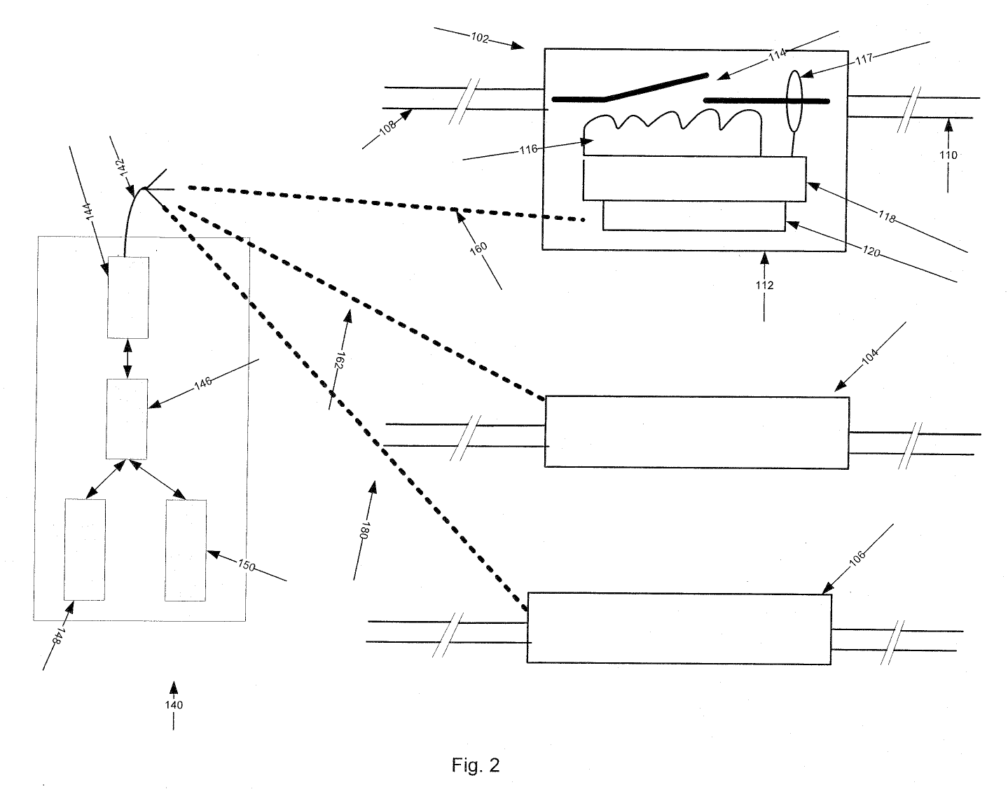

FIG. 2 illustrates a star network. Wi-fi, USB Wireless and Bluetooth all use a star network in their wireless function. Note that connection 164 and 166 in FIG. 1 do not exist in FIG. 2. Rather, wireless connection 180 is shown connecting module 106 to base unit 140.

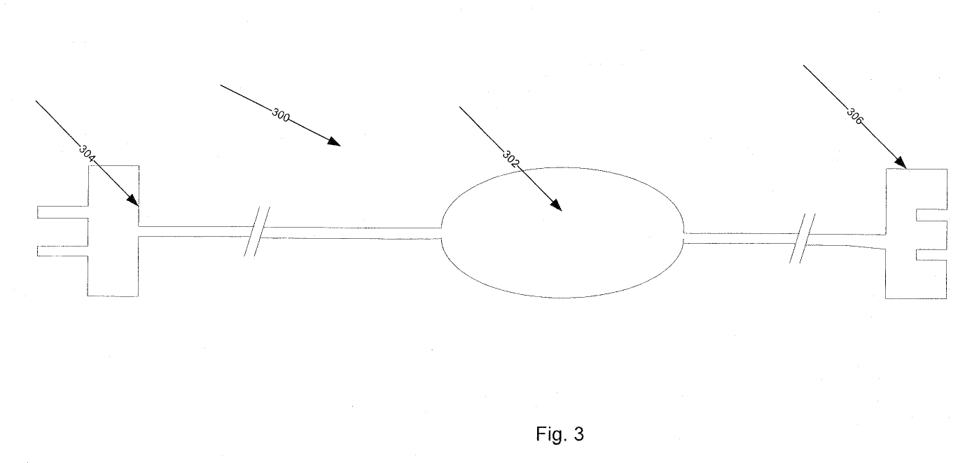

Power distribution devices may take on a number of different forms with little change in functionality. FIGS. 2-6 show some of the possible forms. FIG. 3 shows one embodiment of the present invention as a power distribution device in the form of a wireless smart power cord 300 having a module 302 equivalent to the module 112 described previously. This module 302 is placed between the plugs 304 and 306. The module 302 may be formed contiguously within the sheeting of the power cable 300, or may be a distinct unit which must be plugged in itself into the power cable 300.

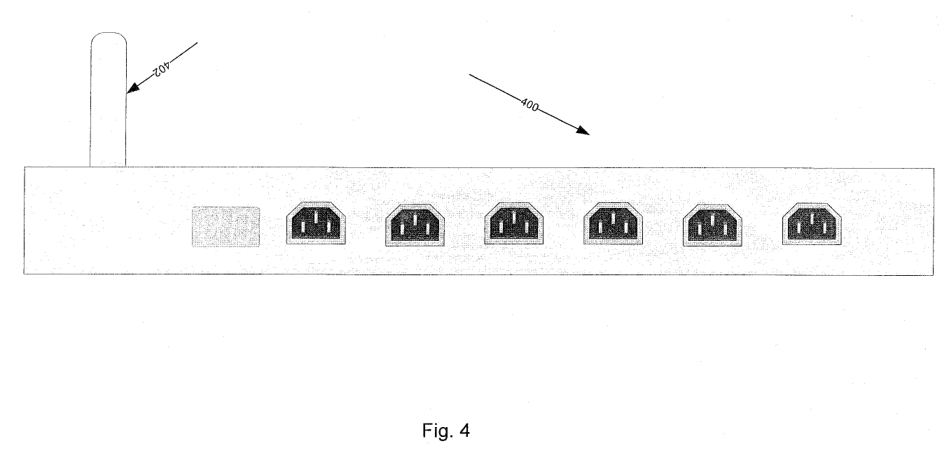

FIG. 4 shows one embodiment of the present invention as a wireless smart power distribution device in the form of a PDU 400 with multiple outlets. This PDU 400 has a USB device 402 or “dangle” attached. This USB device 402 functions as wireless unit 120 as described previously. This is but one possible implementation of wireless unit 120 in a PDU 400. As another example, not shown in this figure, wireless unit 120 may be integrated within the PDU 400.

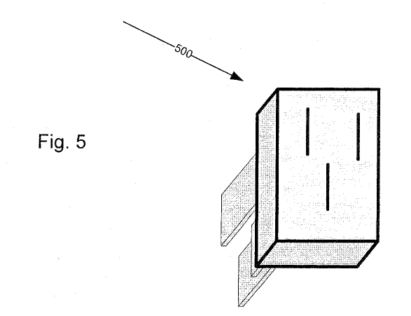

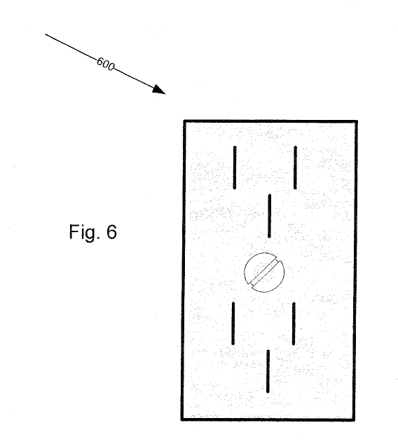

FIG. 5 shows one embodiment of the present invention as a plug-in wireless smart outlet 500. FIG. 6 shows one embodiment of the present invention as a fixed wireless smart outlet 600. Plug-in wireless smart output 506 wireless smart outlet 600 are suitable for use in residential applications.

As will be appreciated, numerous variations and combinations of the features discussed above can be utilized without departing from present invention as defined by the claims. Accordingly, the foregoing description of the preferred embodiments should be taken by way of illustration rather than by way of limitation of the present invention.

What is claimed:

1. A system for monitoring and control of power distribution comprising:
a power distribution device having a module,
said module having a switch with an open and closed position,
a relay which controls the switch,
a sensor which senses certain electrical characteristics,
a device wireless unit for maintaining a wireless connection including a device antennae for transmitting and receiving RF signals, and
a device microcontroller which controls the relay, the sensor, and the device wireless unit;
an input line for carrying electric power with certain electrical characteristics into the module, and
an output line for carrying electric power with the certain electrical characteristics out of the module;
a base station having an antennae for transmitting and receiving RF signals,
a base wireless unit for maintaining a wireless connection,
a network port, and
an interface to a computer
a base microcontroller for controlling the base wireless unit, the network port,
and the interface to a computer,
a wireless connection between said power distribution device and base station;
wherein said base microcontroller may issue instructions to said device microcontroller over said wireless connection to have said relay set the switch in a open or closed position; and
wherein said sensor may transmit data regarding the certain electrical characteristics from said power distribution device to said base station via said wireless connection

2. The system of claim 1, wherein the power distribution device is embodied in a switched power cord.

3. The system of claim 1, wherein the power distribution device is embodied in a power distribution unit.

4. The system of claim 3, wherein the device wireless unit is embodied in a USB stick.

5. The system of claim 1, wherein the electrical characteristics comprise either voltage or current.

6. The system of claim 1, wherein the power distribution device is embodied in a plug-in wall outlet.

7. The system of claim 1, wherein the power distribution device is embodied in an integrated wall outlet.

8. The system of claim 1, wherein the device wireless unit employs a Z-Wave protocol.

9. The system of claim 1, wherein the device wireless unit employs a Wi-Fi protocol.

10. The system of claim 1, wherein the device wireless unit employs a Bluetooth protocol.

11. The system of claim 1, wherein the device wireless unit employs a Zigbee protocol.

12. The system of claim 1, wherein the device wireless unit employs a Wireless USB protocol.

13. A method for monitoring power distribution, comprising the steps of:
sensing electrical characteristics of power transmitted over a power line via a sensor;
sending said sensed electrical charaicteristic data through a device microcontroller of a power distribution device to a device wireless unit;
transmitting said electrical characteristics data from said device wireless unit through a device antenna over a wireless connection;
receiving said electrical characteristics data over said wireless connection at a antenna of a base wireless unit of a base station;
processing said received electrical characteristics data at said base microcontroller;
sending said electrical characteristics data via a network port or interface to a computer.

14. The method of claim 13, wherein the step of sensing electrical characteristics data of power over a power line includes sensing the voltage or current.

15. The method of claim 13, wherein the step of transmitting said electrical characteristics data includes the step of formatting the data to be transmitted over a Z-Wave, protocol.

16. The method of claim 13, wherein the step of transmitting said electrical characteristics data includes the step of formatting data to be transmitted over a Wi-Fi protocol.

17. The method of claim 13, wherein the step of transmitting said electrical characteristics data includes the step of formatting data to be transmitted over a Wireless USB protocol.

18. The method of claim 13, wherein the step of transmitting said electrical characteristics data includes the step of formatting data to be transmitted over a Bluetooth protocol.

19. A method of controling power distribution, comprising the steps of:
receiving a software switch command a via a network port or interface to a computer;
processing said software switch command via a base unit microcontroller;
transmitting said software switch command from a base wireless unit through a base antenna to a antenna in a power distribution device;
interpreting the switch command via a device microcontroller;
actuating a relay to open or close a switch in the power distribution device depending on the switch command.

20. A system for monitoring and controling power distribution in a data center, comprising the steps of:
establishing a mesh network between a number of power distribution devices and a base station using the Z-Wave protocol;
introducing interference between any one of the number of power distribution devices and the base station;
rerouting transmissions from the one of the number of participation devices to the base station through other of the number of power distribution devices;
wherein the transmissions include electrical data and or switch commands.
